(19) United States
(12) Patent Application Publication
(10) Pub. No.: US 2012/0251192 A1
(43) Pub. Date: Oct. 4, 2012

(54) IMAGE FORMING APPARATUS

(75) Inventor: Tadashi KIYAMA, Kanagawa (JP)

(73) Assignee: FUJI XEROX CO., LTD., Tokyo (JP)

(21) Appl. No.: 13/267,293

(22) Filed: Oct. 6, 2011

(30) Foreign Application Priority Data
Mar. 28, 2011 (JP) 2011-070890

(51) Int. Cl. G03G 15/01

(52) U.S. Cl. 399/298

(57) ABSTRACT

An image forming apparatus includes: plural image holding members arranged in parallel to hold toner images of different colors on surfaces thereof, respectively; an exposing device exposing the image holding members to form electrostatic latent images of the different colors on the surfaces, respectively; a developing device developing the electrostatic latent images to form toner images of the different colors, respectively; plural transfer members disposed to face the image holding members and transferring the toner images to a recording medium with an application of a transfer bias; a transport member transporting a recording medium to the image holding members; a calculation unit that calculates a correction value of an exposure time point; and a control unit controlling the exposure time point on the basis of the correction value.

### CROSS-REFERENCE TO RELATED APPLICATIONS

This application is based on and claims priority under 35 USC 119 from Japanese Patent Application No. 2011-070890 filed Mar. 28, 2011.

### BACKGROUND

### Technical Field

The present invention relates to an image forming apparatus.

### SUMMARY

According to an aspect of the invention, there is provided an image forming apparatus including: plural image holding members that are arranged in a line shape and that hold toner images of different colors on surfaces thereof, respectively; an exposing device that exposes the charged surfaces of the image holding members on the basis of image data of the different colors to form electrostatic latent images of the different colors on the surfaces, respectively; a developing device that develops the electrostatic latent images formed on the surfaces of the image holding members to form toner images of the different colors, respectively; plural transfer members that are disposed to face the image holding members, respectively, and that transfer the toner images formed on the image holding members to a recording medium directly pinched and transported between the image holding members and the transfer members with an application of a transfer bias; a transport member that is disposed further upstream in a recording medium transporting direction than the image holding member disposed most upstream in the recording medium transporting direction and that transports a recording medium to the image holding member; a calculation unit that calculates a correction value of an exposure time point of causing the exposing device to expose the surface of the image holding member disposed further downstream in the recording medium transporting direction than one of the image holding members on the basis of an actually-calculated value which is an actually-elapsed time until the recording medium arrives at the one image holding member after the recording medium is transported from the transport member disposed further upstream in the recording medium transporting direction than the one image holding member or after the recording medium arrives at the image holding member disposed further upstream in the recording medium transporting direction than the one image holding member and a theoretical value which is a theoretical time until the recording medium arrives at the one image holding member after the recording medium is transported from the transport member disposed further upstream in the recording medium transporting direction than the one image holding member or after the recording medium arrives at the image holding member disposed further upstream in the recording medium transporting direction than the one image holding member; and a control unit that controls the exposure time point of the exposing device on the basis of the correction value calculated by the calculation unit.

### BRIEF DESCRIPTION OF THE DRAWINGS

Exemplary embodiments of the present invention will be described in detail based on the following figures, wherein:

FIG. 1 is a flowchart illustrating the control of an exposing device in an image forming apparatus according to an exemplary embodiment of the invention;

FIG. 2 is a graph illustrating a variation in transfer bias of a transfer roll used in the image forming apparatus according to the exemplary embodiment;

FIG. 3 is a graph illustrating a variation in transfer bias of the transfer roll used in the image forming apparatus according to the exemplary embodiment;

FIG. 4 is a diagram illustrating a process cartridge of the image forming apparatus according to the exemplary embodiment;

FIG. 5 is a diagram illustrating process cartridges and the like of the image forming apparatus according to the exemplary embodiment; and

FIG. 6 is a diagram schematically illustrating the configuration of the image forming apparatus according to the exemplary embodiment of the invention.

### DETAILED DESCRIPTION

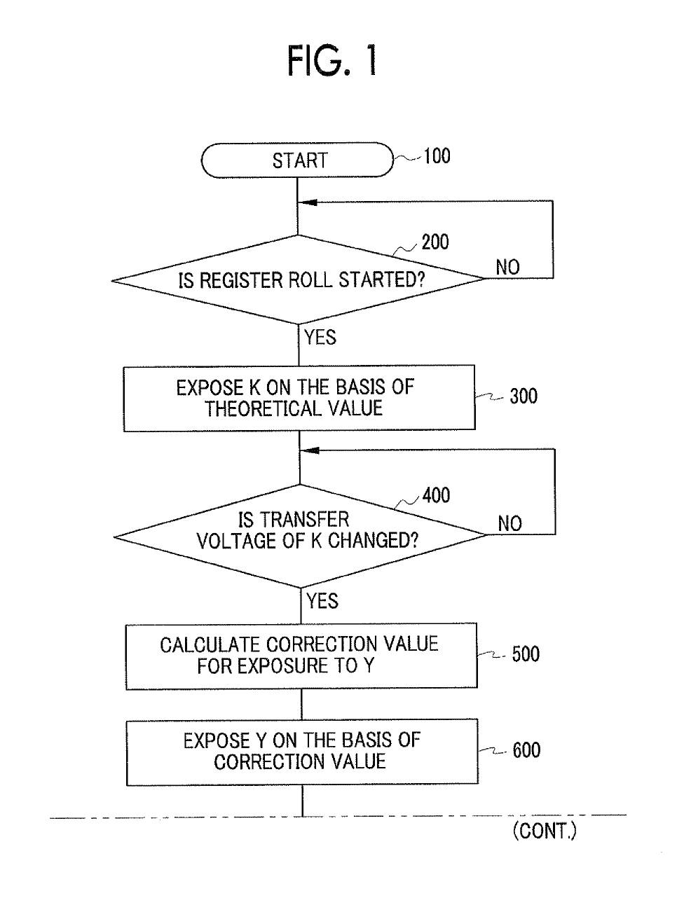

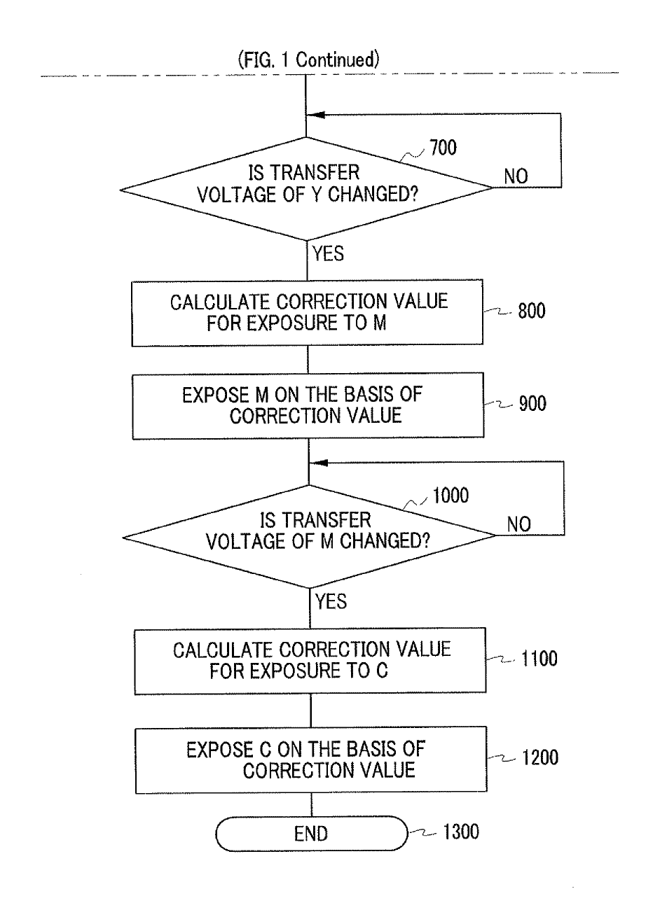

An example of an image forming apparatus according to an exemplary embodiment of the invention will be described with reference to FIGS. 1 to 6. Arrow UP in the drawings represents the upside in the vertical direction.

### Overall Configuration

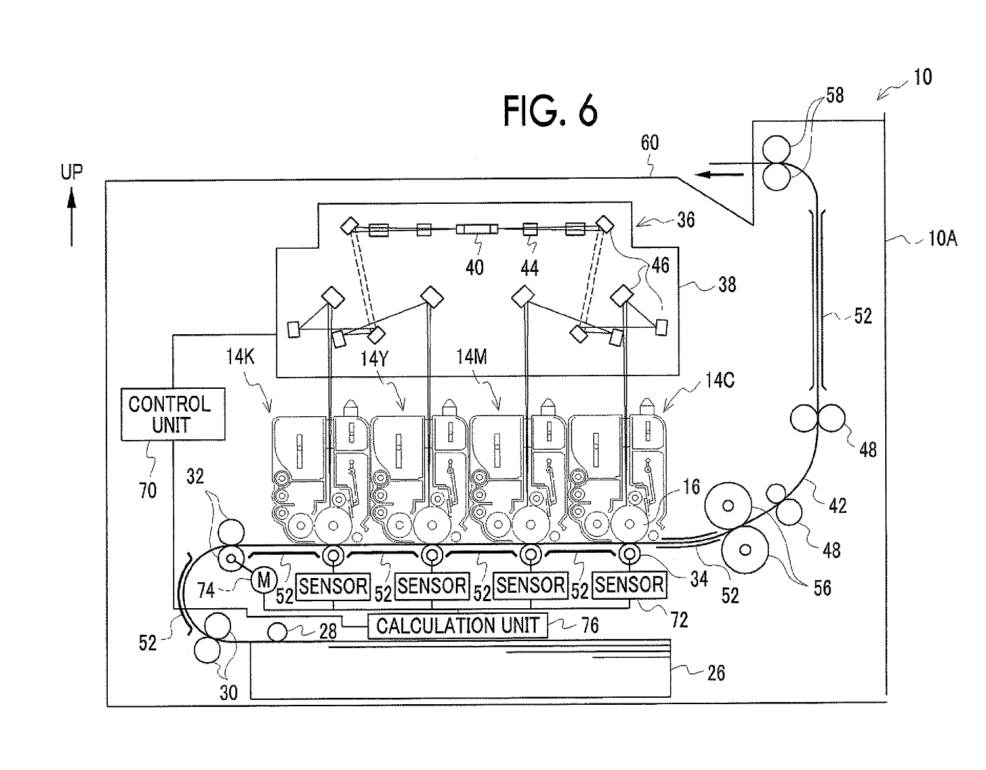

As shown in FIG. 6, process cartridges 14 of four colors (black, yellow, magenta, and cyan in this exemplary embodiment) are arranged in parallel in the horizontal direction in the image forming apparatus 10.

In the following description, letters (K, Y, M, and C) corresponding to the colors are added to reference numerals when the colors are distinguished from each other, and the letters corresponding to the colors are not added when they are not distinguished from each other.

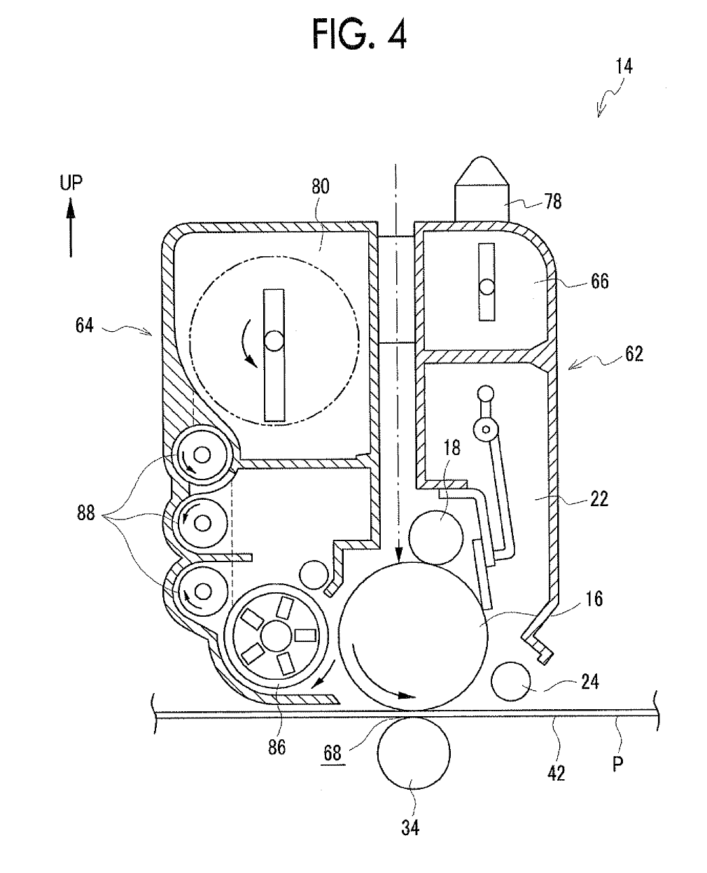

As shown in FIG. 4, each process cartridge 14 includes a photosensitive member cartridge 62 having an image holding member 16 and a developing device 64 as an example of the developing device.

The photosensitive member cartridge 62 includes an image holding member 16 on which an electrostatic latent image is formed, a cleaning device 22, a charging roll 18, and an erase lamp 24 arranged around the image holding member 16, and a sub toner supply unit 66 disposed in parallel with the cleaning device 22.

The sub toner supply unit 66 is provided with a pair of support protrusions 78 extending in a direction perpendicular to the axis direction of the image holding member 16. The process cartridge 14 is positioned with respect to the image forming apparatus 10 by inserting the support protrusions 78 into cartridge support holes (not shown in the drawing) of the image forming apparatus 10.

The developing device 64 includes a developing roll 86 that supplies toner included in a developer to the electrostatic latent image formed on the image holding member 16 while rotating to visualize the electrostatic latent image into a toner image, plural transport augers 88 that transports the toner to the developing roll 86, and a toner chamber 80 that contains supply toner.

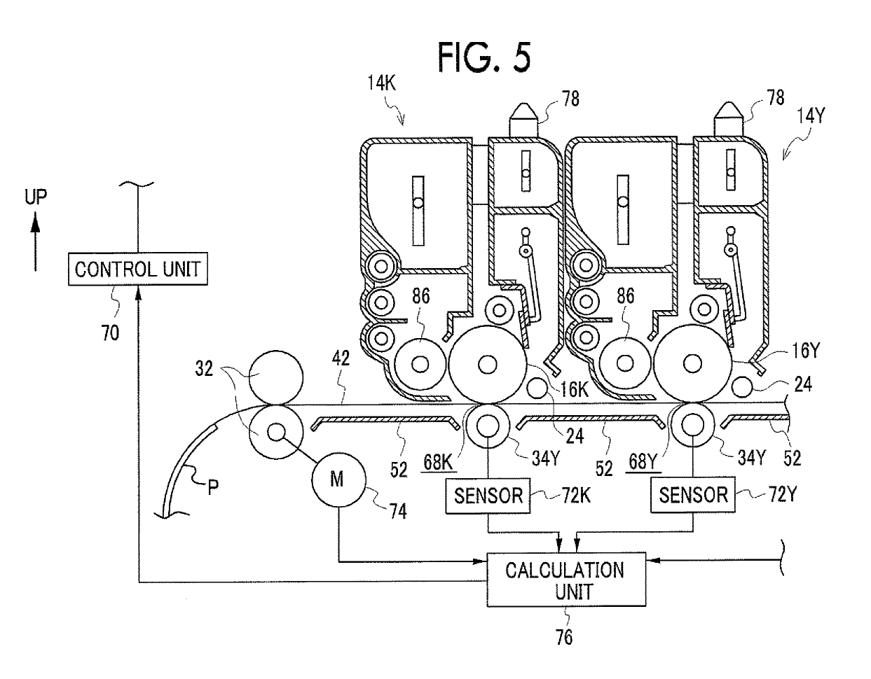

As shown in FIG. 6, a sheet feed unit 26 in which sheet members P are piled is disposed in the lower part of the image forming apparatus 10. A pickup roll 28 that picks up a sheet member P at a predetermined time point is disposed so as to be in contact with the uppermost sheet member P piled in the sheet feed unit 26. The sheet member P picked up from the sheet feed unit 26 by the pickup roll 28 is transported to a transport passage 42 of the sheet member P via a transport roll 30 and a register roll 32 as an example of the transport member. The register roll 32 temporarily stop the sheet member P to adjust the transport time point of transporting the sheet member P to a transfer part 68 (see FIG. 5) formed by the opposing parts of the image holding member 16 and a transfer roll 34 to be described later.

The process cartridges 14 (see FIG. 4) arranged in the horizontal direction are sequentially arranged in the order of black, yellow, magenta, and cyan (K, Y, M, and C) from the upstream side in the sheet member P transporting direction of the transport passage 42 (hereinafter, simply referred to as “upstream side”). An exposing device 36 that irradiates the image holding members 16 of the process cartridges 14 with scanning light to expose the surfaces of the image holding members 16 is disposed above the process cartridges 14.

The exposing device 36 includes a semiconductor laser (not shown in the drawings), a polygonal mirror 40, an imaging lens 44, and mirrors 46 in a case 38. Light emitted from the semiconductor laser is deflected by the polygonal mirror 40 and is applied to the image holding members 16 via the imaging lens 44 and the mirrors 46. Accordingly, electrostatic latent images corresponding to image information are formed on the image holding members 16. A control unit 70 controlling the exposure time point of causing the exposing device 36 to expose the image holding members 16 is additionally provided. The details of the control unit 70 will be described later.

A transfer roll 34 as an example of the transfer member transferring the toner image formed on the image holding member 16 of each color to a sheet member P is disposed at a position facing the corresponding image holding member 16 with the transport path 42 interposed therebetween. A transfer voltage is applied to the transfer roll 34 and the toner image formed on the corresponding image holding member 16 is transferred to the sheet member P pinched and transported between the transfer roll 34 and the image holding member 16 without using a belt by causing a transfer current to flow between the image holding member 16 and the transfer roll 34.

A plate-like guide member 52 guiding the sheet member P along the transport path 42 is disposed in the transport path 42 between the transfer rolls 34 and the like.

A fixing device 56 fixing the toner images formed on the sheet member P to the sheet member P by the use of heat and pressure is disposed downstream in the sheet member P transporting direction (hereinafter, simply referred to as downstream) than the process cartridges 14.

Plural transport rolls 48 transporting the sheet member P having the toner image fixed thereto by the fixing device 56 and a discharge roll 58 discharging the sheet member P having the toner image fixed thereto to a discharge unit 60 disposed in the upper part of the apparatus body 10A are disposed more downstream than the fixing device 56.

In the image forming apparatus 10 having the above-mentioned configuration, an image is formed on a sheet member P as follows.

As shown in FIG. 4, the charging roll 18 supplied with a voltage uniformly negatively charges the surface of the corresponding image holding member 16 to a predetermined charged-portion potential.

The exposing device 36 (see FIG. 6) performs an exposing process to form an electrostatic latent image on the image holding member 16 so that the charged image portion on the image holding member 16 has a predetermined exposed-portion potential.

That is, the control unit 70 controls the exposure time point and modulates exposing light by turning on and off a semiconductor laser (not shown) on the basis of image data supplied from a supply unit not shown, whereby electrostatic latent images corresponding to the colors are formed on the image holding members 16, respectively.

The toner included in the developer is supplied to the electrostatic latent image formed on the corresponding image holding member 16 by the developing roll 86 disposed in the developing device 64, whereby the electrostatic latent image is visualized as a toner image.

As shown in FIG. 6, a sheet member P piled on the sheet feed unit 26 is picked up to the transport path 42 by the pickup roll 28. The sheet member P is transported to a transfer part 68 (see FIG. 5) at a predetermined time point by the transport roll 30 and the register roll 32. The toner images formed on the image holding members 16 are transferred to the sheet member P by the transfer rolls 34. The toner images transferred to the sheet member P are fixed to the sheet member P by the fixing device 56 and the sheet member P having the toner images fixed thereto is discharged to the discharge unit 60 by the discharge roll 58.

### Partial Configuration

The control unit 70 and the like will be described below. As shown in FIGS. 5 and 6, the transfer rolls 34 supplied with a transfer voltage are subjected to constant current control. A sensor 72 sensing the transfer voltage of each color is disposed in the transfer roll 34 of the corresponding color. The constant current control means a control to match an output current value with a target current value.

The register roll 32 adjusting the transport time point is provided with a motor 74 driving the register roll 32.

A calculation unit 76 comparing a measured value which is an actual elapsed time until the sheet member P arrives at the nip part between the transfer roll 34K and the image holding member 16K after the sheet member P is sent by the register roll 32 and a theoretical value which is a theoretical time until the sheet member P arrives at the nip part between the transfer roll 34K and the image holding member 16K is provided. The calculation unit 76 calculates a correction value of an exposure time point when the exposing device 36 exposes the surface of the image holding member 16Y disposed more downstream than the image holding member 16K on the basis of the measured value and the theoretical value.

The calculation unit 76 compares the measured values which are actual elapsed times until the sheet member P arrives at the image holding members 16Y and 16M after the sheet member P arrives at the image holding members 16K and 16Y disposed more upstream than the image holding members 16Y and 16M with the theoretical values which are theoretical times until the sheet member P arrives at the image holding members 16Y and 16M. The calculation unit 76 calculates a correction value of the exposure time point when the exposing device 36 exposes the surfaces of the image holding members 16M and 16C disposed more downstream than the image holding members 16Y and 16M.

The control unit 70 controls the exposure time point of the exposing device 36 on the basis of the correction value calculated by the calculation unit 76.

The specific control of the control unit 70 will be described below along with the operation.

### Operation

The operation and the like of the control unit 70 will be described with reference to the flowchart shown in FIG. 1.

As shown in FIG. 1, the control process is started in step 100 when the image forming apparatus 10 receives an image forming instruction and the process of step 200 is performed.

As shown in FIGS. 1, and 6, the motor 74 drives the register roll 32 so as to adjust the transport time point of transporting the sheet member P to the transfer part 68K and the register roll 32 is rotationally driven (started) in step 200. It is determined whether the register roll 32 is driven (started), and the process of step 300 is performed when it is driven.

In step 300, the exposing device 36 exposes the surface of the black image holding member 16K on the basis of the theoretical interval value which is a theoretical time until the sheet member P transported from the register roll 32 arrives at the transfer part 68K, and the process of step 400 is performed.

In step 400, by causing the sensor 72K to sense a variation of the transfer voltage (transfer bias) of the transfer roll 34K, the calculation unit 76 determines an inrush time point when the leading edge of the sheet member P enters the transfer part 68K and the process of step 500 is then performed.

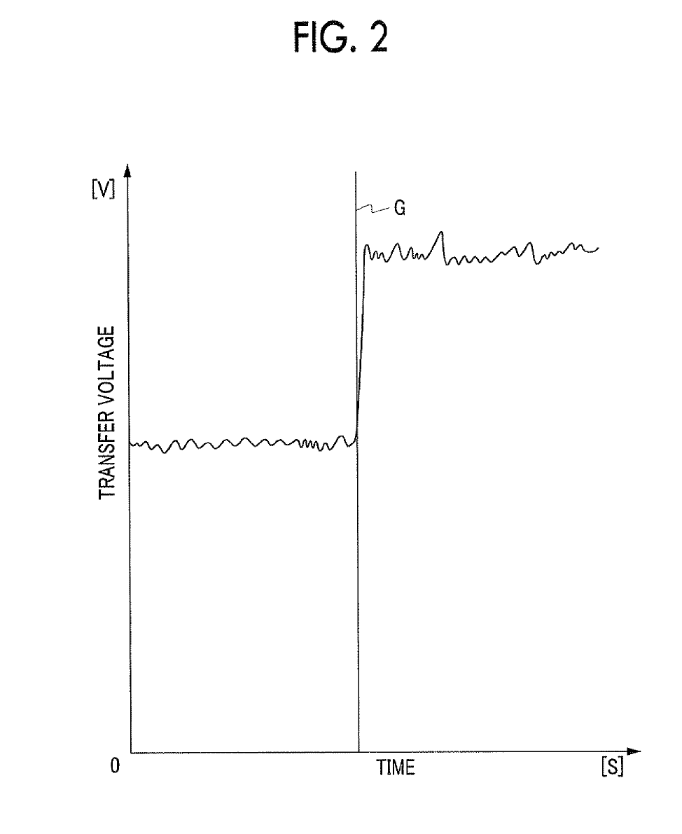

Specifically, the vertical axis of the graph shown in FIG. 2 represents the transfer voltage (V) sensed by the sensor 72K and the horizontal axis in FIG. 2 represents the time (s) which is set to 0 when the sheet member P is sent from the register roll 32 (when the register roll 32 is driven).

At the time point when the transfer voltage is rapidly raised by nipping the sheet member P between the image holding member 16K and the transfer roll 34K (see FIG. 5) in the transfer part 68K (at the arrival time point when the sheet member P arrives at the image holding member 16K), the calculation unit 76 recognizes the arrival time point when the leading edge of the sheet member P arrives at the image holding member 16.

That is, the time G elapsing from the time point (the transport time point) when the sheet member P is sent by the register roll 32 to the arrival time point when the leading edge of the sheet member P arrives at the image holding member 16K is a measured interval value. For example, when the process speed is 100 mm/sec, it is possible to sense the difference in speed of the sheet member P of 0.1 mm (100 μm) by monitoring the sheet member at an interval of 1 m/sec.

In this way, the calculation unit 76 recognizes the measured interval value when the sheet member P arrives at the image holding member 16K on the basis of the variation of the transfer bias of the black transfer roll 34K, and the process of step 500 is then performed.

In step 500, the calculation unit 76 calculates a correction value of the exposure time point when the exposing device 36 exposes the surface of the image holding member 16Y disposed more downstream than the image holding member 16K on the basis of the time G as the measured interval value and the time H which is a theoretical interval value as a theoretical arrival time until the sheet member P arrives at the image holding member 16K. For example, when the measured interval value is slower by X(s) than the theoretical interval value, the correction value is calculated to delay the exposure time point by X(s). Then, the process of step 600 is performed.

The theoretical interval value is a theoretical time H(s) until the sheet member P arrives at the image holding member 16 after the sheet member P is sent from the register roll 32 (the transport time point) or after the sheet member P arrives at the image holding member 16 disposed upstream (the arrival time point).

In step 600, the exposing device 36 exposes the surface of the image holding member 16Y on the basis of the correction value calculated by the calculation unit 76 in step 500, and then the process of step 700 is performed.

In step 700, by causing the sensor 72Y to sense a variation of the transfer voltage (transfer bias) of the transfer roll 34Y, the calculation unit 76 determines an arrival time point when the leading edge of the sheet member P arrives at the image holding member 16Y.

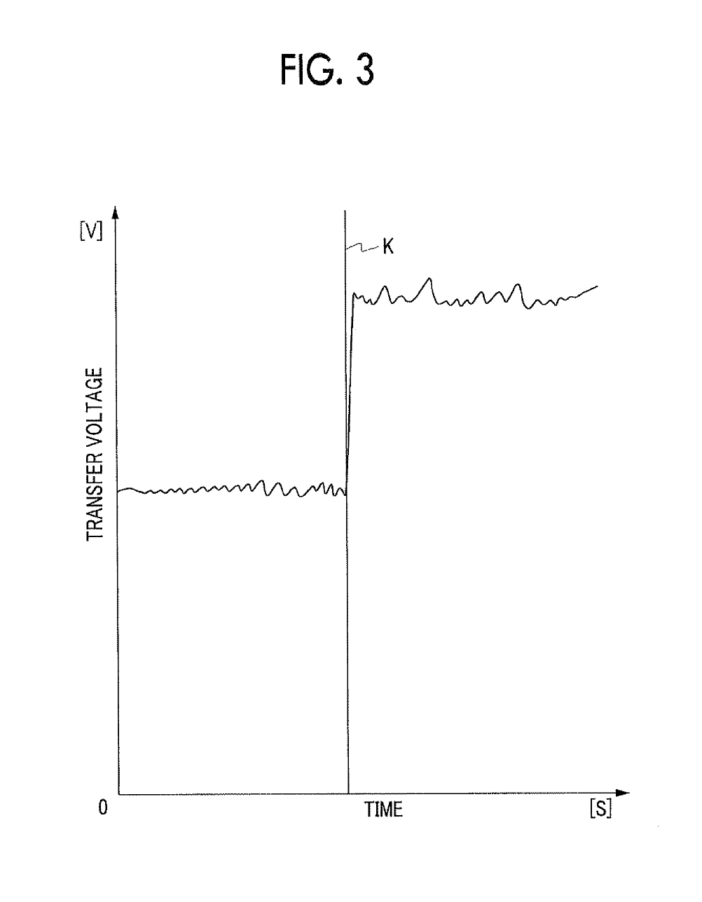

Specifically, the vertical axis of the graph shown in FIG. 3 represents the transfer voltage (V) sensed by the sensor 72Y and the horizontal axis in FIG. 3 represents the time (s) which is set to 0 when the sheet member P arrives at (enters) the image holding member 16K disposed more upstream than the image holding member 16Y (the above-mentioned G).

At the time point K(s) when the transfer voltage is rapidly raised by nipping the sheet member P between the image holding member 16Y and the transfer roll 34Y (see FIG. 5) in the transfer part 68Y, the calculation unit 76 recognizes the arrival time point when the leading edge of the sheet member P arrives at the transfer part 68Y.

That is, the measured value which is the elapsed time until the sheet member P arrives at the image holding member 16Y having a yellow toner image formed on the surface thereof after the sheet member P arrives at the image holding member 16K disposed more upstream than the image holding member 16Y is a time K(s).

In this way, the calculation unit 76 recognizes the measured interval value when the sheet member P arrives at the image holding member 16Y on the basis of the variation of the transfer bias of the yellow transfer roll 34Y, and the process of step 800 is then performed.

In step 800, the calculation unit 76 calculates a correction value of the exposure time point when the exposing device 36 exposes the surface of the image holding member 16M on the basis of the time K as the measured value and the time H as the theoretical value which is the theoretical time until the arrival. Then, the process of step 900 is performed.

In step 900, the exposing device 36 exposes the surface of the image holding member 16M on the basis of the correction value calculated by the calculation unit 76 in step 800, and then the process of step 1000 is performed.

In step 1000, by causing the sensor 72M to sense a variation of the transfer voltage (transfer bias) of the transfer roll 34M, the calculation unit 76 determines an arrival time point.

Specifically, like step 700, the calculation unit 76 recognizes a measured value which is the time L elapsing until the sheet member P arrives at the image holding member 16M after the sheet member P arrives at the image holding member 16Y disposed more upstream than the image holding member 16M, and then the process of step 1100 is performed.

In step 1100, the calculation unit 76 calculates a correction value of the exposure time point when the exposing device 36 exposes the surface of the image holding member 16C on the basis of the time L as the measured value and the time H as the theoretical value which is the theoretical time until the arrival. Then, the process of step 1200 is performed.

In step 1200, the exposing device 36 exposes the surface of the cyan image holding member 16C on the basis of the correction value calculated by the calculation unit 76 in step 1100. When the surface of the image holding member 16C is exposed by the exposing device 36, the procedure is ended in step 1300.

As described above, by calculating the correction value of the exposure time point in the exposing device 36 on the basis of the time point (the transport time point) when the sheet member P is sent from the register roll 32 or the time point (the arrival time point) when the sheet member P arrives at the image holding member 16 disposed upstream, it is possible to suppress the color deviation of the colors in the sheet member P transporting direction without increasing the size of the apparatus body 10A, compared with the case where sensors are disposed between the image holding members of the colors and the correction value is calculated on the basis of the detection signals of the sensors.

A black toner image not requiring the color superimposing is first transferred to the sheet member P. That is, by using the first exposure to form a black toner image not requiring the color superimposing without causing the exposing device 36 to expose the surface of the image holding member 16 on the basis of the correction value calculated by the calculation unit 76, it is possible to make the color deviation inconspicuous.

After the black toner image not requiring the color superimposing and the yellow toner image of which the color deviation is inconspicuous are first transferred, the magenta toner image and the cyan toner image of which the color deviation is conspicuous are transferred to the sheet member P. That is, since the electrostatic latent image used to form the magenta and cyan toner images of which the color deviation is conspicuous is formed on the basis of the correction values calculated by the calculation unit 76, it is possible to make the color deviation inconspicuous.

Although the specific exemplary embodiment of the invention has been described in detail, it will become apparent to those skilled in the art that the invention is not limited to the exemplary embodiment but various other embodiments may be thought out within the scope of the invention. For example, in the above-mentioned exemplary embodiment, the time point of starting transferring the toner image to the sheet member P (the leading edge of the sheet member P enters the transfer part 68) is recognized by sensing the variation of the transfer voltage of the transfer roll 34 subjected to the constant current control. However, the invention is not limited to the constant current control, but the time point of starting transferring the toner image to the sheet member P may be recognized by sensing the variation of a transfer current of the transfer roll subjected to a constant voltage control.

In the above-mentioned exemplary embodiment, the measured values when the sheet member P arrives at the Y, M, and C image holding members 16 are calculated on the basis of the time point when the sheet P arrives at the image holding member 16 disposed upstream. However, all the measured values may be calculated on the basis of the transport time point when the sheet member is sent from the transport mechanism such as the register roll.

Although not particularly mentioned in the above-mentioned exemplary embodiment, the time points on the downstream sides may be acquired by averaging the plural measured values on the upstream sides or the like. In this case, a measuring error is absorbed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of image holding members that are arranged in a line shape and that hold toner images of different colors on surfaces thereof, respectively;
an exposing device that exposes the charged surfaces of the image holding members on the basis of image data of the different colors to form electrostatic latent images of the different colors on the surfaces, respectively;
a developing device that develops the electrostatic latent images formed on the surfaces of the image holding members to form toner images of the different colors, respectively;
a plurality of transfer members that are disposed to face the image holding members, respectively, and that transfer the toner images formed on the image holding members to a recording medium directly pinched and transported between the image holding members and the transfer members with an application of a transfer bias;
a transport member that is disposed further upstream in a recording medium transporting direction than the image holding member disposed most upstream in the recording medium transporting direction and that transports a recording medium to the image holding member;
a calculation unit that calculates a correction value of an exposure time point of causing the exposing device to expose the surface of the image holding member disposed further downstream in the recording medium transporting direction than one of the image holding members on the basis of an actually-calculated value which is an actually-elapsed time until the recording medium arrives at the one image holding member after the recording medium is transported from the transport member disposed further upstream in the recording medium transporting direction than the one image holding member or after the recording medium arrives at the image holding member disposed further upstream in the recording medium transporting direction than the one image holding member and a theoretical value which is a theoretical time until the recording medium arrives at the one image holding member after the recording medium is transported from the transport member disposed further upstream in the recording medium transporting direction than the one image holding member or after the recording medium arrives at the image holding member disposed further upstream in the recording medium transporting direction than the one image holding member; and
a control unit that controls the exposure time point of the exposing device on the basis of the correction value calculated by the calculation unit.

2. The image forming apparatus according to claim 1, wherein the actually-calculated value is calculated on the basis of an arrival time point when the recording medium arrives at the one image holding member, a transport time point when the recording medium is transported from the transport member disposed further upstream in the recording medium transporting direction than the one image holding member or an arrival time point when the recording medium arrives at the image holding member disposed further upstream in the recording medium transporting direction than the one image holding member.

3. The image forming apparatus according to claim 1, wherein the image holding member having a black toner image formed on the surface thereof is disposed further upstream in the recording medium transporting direction than the image holding members having toner images of the other colors formed on the surfaces thereof.

4. The image forming apparatus according to claim 2, wherein the image holding member having a black toner image formed on the surface thereof is disposed further upstream in the recording medium transporting direction than the image holding members having toner images of the other colors formed on the surfaces thereof.

5. The image forming apparatus according to claim 1, wherein the image holding members having magenta and cyan toner images formed on the surfaces thereof are disposed further downstream in the recording medium transporting direction than the image holding members having black and yellow toner images formed on the surfaces thereof.

6. The image forming apparatus according to claim 2, wherein the image holding members having magenta and cyan toner images formed on the surfaces thereof are disposed further downstream in the recording medium transporting direction than the image holding members having black and yellow toner images formed on the surfaces thereof.

7. The image forming apparatus according to claim 3, wherein the image holding members having magenta and cyan toner images formed on the surfaces thereof are disposed further downstream in the recording medium transporting direction than the image holding members having black and yellow toner images formed on the surfaces thereof.

8. The image forming apparatus according to claim 4, wherein the image holding members having magenta and cyan toner images formed on the surfaces thereof are disposed further downstream in the recording medium transporting direction than the image holding members having black and yellow toner images formed on the surfaces thereof.
